(19) United States
(12) Patent Application Publication
(10) Pub. No.: US 2017/0226993 A1
(43) Pub. Date: Aug. 10, 2017

(54) METHODS AND SYSTEMS FOR HARVESTING MOTIONAL ENERGY OF LOADS INSIDE A MOVING CONTAINER

(71) Applicant: Shuo Cheng, Austin, TX (US)

(72) Inventor: Shuo Cheng, Austin, TX (US)

(21) Appl. No.: 15/418,742

(22) Filed: Jan. 29, 2017

Related U.S. Application Data
(60) Provisional application No. 62/292,509, filed on Feb. 8, 2016.

(51) Int. Cl. F03G 7/08; H02K 7/18; H02K 35/02; F03G 1/10

(52) U.S. Cl. CPC F03G 7/08; F03G 1/10; H02K 7/1876; H02K 35/02

(57) ABSTRACT

Embodiments disclosed herein provide systems and methods for harvesting motional energy, wherein components of the motional energy harvester are disposed, embedded, positioned, etc. within a container. By positioning the components of the motional energy harvester within the container, embodiments may not include large add-ons that coupled to an outer surface of the container.

### CROSS-REFERENCE TO RELATED APPLICATIONS

This application claims a benefit of priority under 35 U.S.C. §119 to Provisional Application No. 62/292,509 filed on Feb. 8, 2016, which is fully incorporated herein by reference in its entirety.

### BACKGROUND INFORMATION

Field of the Disclosure

Examples of the present disclosure relate to techniques for a portable power supply that is charged by relative motion between two frames. More specifically, embodiments relate to harvesting energy loads, wherein the loads are positioned within a moving container.

Background

A power supply is a device that supplies electric energy to an electrical device. The primary function of a power supply is to transfer electrical energy stored within the power supply to the electrical device. However, conventional portable power supplies have a limited charge, which is not always sufficient to supply electronic power to an electrical device over long periods of times.

To increase the amount of energy stored by a portable power supply, conventional systems have incorporated solar panels and motional energy harvesters. The solar panels generate power from ambient light. However, ambient light is not always available or may not generate sufficient power.

To overcome this deficiency, conventional systems have incorporated motional energy harvesters to supplement the solar panels. Yet, Conventional power supplies utilizing motional energy harvesters require a large moving mass to generate a useful amount of power. If conventional motional energy harvesters do not have sufficient mass, then they generate less power than an electrical device consumes. To create the sufficient mass, conventional motional energy harvesters generally include an add-on weight, which is included inside the energy harvesting device. In other examples, the weight of a backpack is used as the moving mass. In these implementations, a frame support is attached to the backpack to capture the energy from the backpack's motion. In either cases, the attachment of a large mass or a bulky frame support creates challenges to the portability of these devices.

Furthermore, attempts have been made to position motional energy harvesters inside shoes, and generate power from the total weight of the wearer. However, due to the limited space available to implement the motional energy harvesters inside shoes, it is hard to build a highly efficient energy conversion device within a shoe without making the shoe uncomfortable.

Accordingly, needs exist for more effective and efficient methods and systems for harvesting energy loads, wherein power is generated based on the relative motion of two moving frames.

### SUMMARY

Embodiments disclosed herein provide systems and methods for harvesting motional energy, wherein components of the motional energy harvester are disposed, embedded, positioned, etc. within a container. By positioning the components of the motional energy harvester within the container, the components may increase the mechanical force generated while not including larger add-ons within the energy harvesting device or coupled to an outer surface of the container.

In embodiments, the motional energy harvester may be positioned in an inner frame, wherein the inner frame is positioned between an inner frame and an outer frame of the container. While in use, a user may position items to be carried by the container within the inner frame. The inner frame may be an add-on component that is configured to be removably positioned within the container, or the inner frame may be integrated into an internal layer of the container. Responsive to the inner frame moving relative to the outer frame of the container, mechanical force may be generated. In other embodiments, the motional energy harvester may be positioned within an inner frame. The motional energy harvester may still be configured to generate electrical energy based on the relative motion between the inner frame and an outer frame.

The inner frame may be coupled to the outer frame of the container via an elastic, pivoting, element that moves from a fixed axis, etc. element, such as a spring, elastic band, string, pivot etc. The elastic member may be configured to restrict, control, etc. the movement of the inner frame within the container. The elastic member may compress and decompress to generate mechanical force based on the relative motion of the inner frame and the outer frame of the container. In further embodiments, a set of coils may be configured to extend from an area within the inner frame to the outer frame.

In embodiments, a power generator may be positioned in a hollow chamber within the container, between the outer frame and the inner frame, or alternatively within the inner frame. In embodiments, responsive to the container moving, the inner frame may move relative to the outer frame of the container. The relative motion of the inner frame may create a mechanical force that is applied to the power generator. When the power generator receives the mechanical force, the power generator may convert the mechanical force into electrical energy. The electrical energy may be conditioned by a power conditioning circuit board configured to regulate the voltage that is emitted from power storage units.

In embodiments, the power conditioning circuit board may be configured to be removably coupled within the container and/or inner frame, and may include a rectifier, linear or switching voltage regulator, and protection circuits. Additionally, the power conditioning circuit board may include charging ports or cables that are configured to couple with external devices and/or internal power storage units.

In embodiments, the power storage units may be positioned within the inner frame, or between the inner frame and the outer layer. The power storage units may include charging ports that may be accessibly from inside the inner frame.

Embodiments may be configured to generate a significant amount of electrical energy via contents embedded within a container without including an external attachment, and while the container maintains its portability and non-intrusiveness.

In embodiments, the power generator may include power conversion devices configured to transfer mechanical energy into electrical energy via a plurality of different mechanisms. For example, in a first embodiment, the power conversion device may include a mechanisms configured to convert linear oscillary motion into rotary motion through the use of racks gears, ratchets, etc. The rotary motion may then be applied to a AC or DC generator to generate electricity.

In a second embodiment, the linear socially motion may be directly converted to electricity through a linear power generator. The linear power generator may include one or more permanent magnets, one or more coils, or a piezoelectric material configured to deform in response to the oscillary motion. The linear oscillary motion may cause the coils to move relative to the magnets, and vice versa. This may enable electricity to be generated by the varying magnetic flux inside of the coils. The deflection of the piezoelectric material may also be used to generate power. Furthermore, soft magnetic sheet layers may be used to shield the magnetic field from interfering with other objects positioned inside or outside of the container.

Embodiments may also include two interconnecting frames, such as an inner frame and an outer frame. The frames may be constructed out of light, rigid and strong materials, such as carbon fiber tubes. Fabric may be coupled inside of the inner frame and outside of the outer frame to form a container a bag. A power generator may be coupled between the two frames, and be configured to convert the relative motion of the two frames into electricity.

In embodiments, springs may be couple between the two frames to sustain the relative motion once there is motion on one of the frames. Further, the springs may be configured to provide a buffer for the comfort of the wearer and the safety of the contents in the bag.

In embodiments, the power generator may include one or more pairs of magnetic arrays and one or more coil arrays. In the magnetic array, the magnets are arranged in alternating polarities. The pair of arrays may be arranged so that they are attracting each other, such that they are positioned on an magnetically alternating fashion. This may create a strong alternating field.

Additionally, the magnets may be mounted to the inner frame, and the coil may be mounted to the outer frame, or vice versa. When the inner frame moves relative to the outer frame up and down, the coils will move in a gap between the magnetic arrays. The relative movement of each coil will experience rapid change of magnetic flux, which generates voltage. In further implementations, the magnets may be mounted to the outer frame while the coils may be coupled to the inner frame and extend into a channel between the magnetic plates. In this implementation, responsive to the inner frame and/or outer frame moving, second ends of the coils positioned within the channel will move relative to the magnets. This may cause a voltage to be induced on the coils based on a change of magnetic flux.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a motional energy harvester, according to an embodiment.

FIG. 2 depicts a method of harvesting energy, according to an embodiment.

FIG. 3 depicts a motional energy harvester, according to an embodiment.

FIG. 4 depicts a motional energy harvester, according to an embodiment.

FIG. 5 depicts a method of harvesting energy, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments disclosed herein provide systems and methods for harvesting motional energy, wherein components of the motional energy harvester are disposed, embedded, positioned, etc. within a container. By positioning the components of the motional energy harvester within the container, embodiments may not include large add-ons that couple to an outer surface of the container.

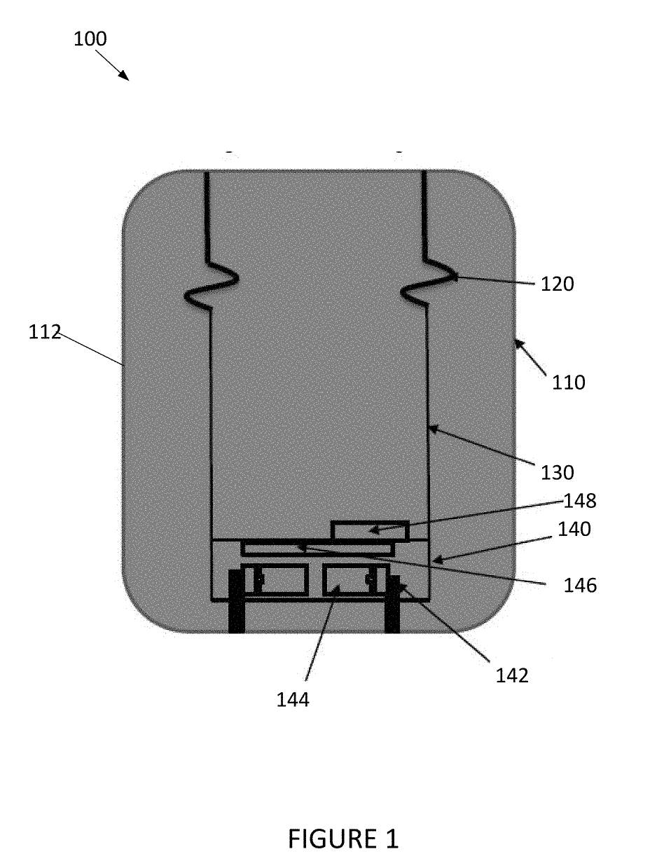

Turning now to FIG. 1, FIG. 1 depicts a motional energy harvester 100. Motional energy harvester may be configured to harness motional energy while a container 110 is being moved. Responsive to motional energy harvester 100 being subject to motional energy, motional energy harvester 100 may be configured to convert the received motional energy to electrical energy. Motional energy harvester 100 may include a container 110, elastic member 120, inner frame 130, outer frame 112, and power conversion device 140.

Container 110 may be any type of container with a partially or fully enclosed space that is configured to contain, store, be moved, and/or transport objects or materials. For example, container 110 may be luggage, a trunk, a backpack, purse, box, barrel, crate, jar, etc. Container 110 may include a hollow inner body, wherein items positioned within container 110 may be protected by being positioned inside of the hollow body. In embodiments, container 110 may be comprised of durable materials that are rigid, partially rigid, or pliable materials.

Elastic member 120 may be comprised of elastic material that is configured to resist a distorting influence or stress to return to its original size and shape when the stress is removed. For example, elastic member 120 may be an elastic band, rubber band, spring, string, etc. A first end of elastic member 120 may be configured to be coupled with an edge of outer frame 112, and a second end of elastic member 120 may be configured to be coupled with inner frame 130. Elastic member 120 may be configured to extend along a circumference positioned within the hollow chamber of container 110. This may increase the amount of mechanical force generated by motional energy harvester 100 without requiring an additional external attachment. In embodiments, responsive to inner frame 130 moving within container 110 relative to the motion of outer frame 112, elastic member 120 may be configured to compress and decompress. In embodiments, elastic member 120 may be able to compress and decompress multiple times, which may increase the amount of times inner frame 130 and outer frame 112 move relative to one another.

Inner frame 130 may be a bag, sack, container, etc. that is configured to be removably coupled within a body of container 110. Inner frame 130 may be configured to be embedded within the hollow chamber of container 110 via elastic member 120, such that inner frame 130 may move independently from outer frame 112 of container 110. Furthermore, movement of the inner frame 130 within container 110 may be controlled, restricted, limited, regulated, etc. by elastic member 120. In embodiments, inner frame 130 may have an open top end, a hollow chamber, and a closed bottom end. A user may position items within the hollow chamber, such as books, electronics, personal items, etc. via the open top end. The mechanical force generated based on the relative movement of inner frame 130 and outer frame 112 may be based on the weight of the items positioned within inner frame 130. In embodiments, by increasing the amount of weight within inner frame 130, the amount of mechanical force generated may increase.

Power conversion device 140 may be a device that is configured to create electrical power responsive to the mechanical force or magnetic flux caused by the relative motion of inner frame 130 and outer frame 112. When power conversion device 140 receives the mechanical force or changes of magnetic flux, the power conversion device 140 may convert the mechanical force and/or magnetic flux into electrical energy.

In embodiments, elements of power conversion device 140 may be positioned within a lower chamber within inner frame 130, or between inner frame 130 and outer frame 112. Accordingly, power conversion device 140 may be housed within container 112 without an external attachment. By positioning the elements of power conversion device 140 within the lower, inner chamber within inner frame 130, the weight of the items within inner frame 130 may increase. This increase in weight may increase the mechanical force caused by the relative motion of inner frame and outer frame 112.

Other elements of power conversion device 140 may be positioned between outer frame 112 of container 110 and a sidewall of inner frame 130. In embodiments, elements of power conversion device 140 may be configured to be coupled to the closed bottom end of inner frame 130 and the outer frame 112 of container 110, wherein elements of power conversion device 140 may be removed from container 110. Accordingly, container 110 may operate as a conventional container or operate as a motional energy harvester 100.

Power conversion device 140 may include a gear chain 142, a power generator 144, a power conditioning circuit board 146, and an energy storage device 148. Elements of power conversion device 140 may be positioned within inner frame 130.

Gear chain 142 may be configured to transmit mechanical power from one place to another, and/or convert mechanical motion from one form to another. A first end of gear chain 142 may be coupled to outer frame 112, and a second end of gear chain 142 may be coupled to power generator 144. In embodiments, the second end of gear chain 142 may be positioned within the lower chamber within inner frame 130. Accordingly, gear chain 142 may traverse the lining of inner frame 130 to couple outer frame 112 to power conversion device 140. In embodiments, responsive to inner frame 130 moving relative to outer frame 112, elastic member 120 may compress or decompress. The compression and decompression of elastic member 120 may restore the relative position between inner frame 130 and outer frame 112, so that the movement of inner frame 130 is repeatable. The movement of inner frame 130 may generate kinetic energy that may move gear chain 142 to transfer the mechanical energy. The gear chain may also convert the linear oscillatory motion to unidirectional or bidirectional rotary motion.

Power generator 144 may be a device that is configured to convert mechanical energy or changes to a magnetic flux to electrical energy for use in an external circuit. More specifically, power generator 144 may create electrical energy responsive to the relative motion of the inner frame and the outer frame. When inner frame moves relative to the outer layer, gear chain 142 may transmit mechanical energy to power generator 144, which in turn may create electrical energy. Additionally, power generator 144 may be configured to be positioned within the lower chamber within inner frame 130. The elastic member helps restore the relative position between the inner frame 130 and the outer layer, so that the relative motion is repeatable. In other embodiments, power generator 144 may generate power responsive to relative movement of coils within the outer frame 112 and a magnetic array, wherein the movement of the coils in relation to the magnetic array causes a change in magnetic flux that generates voltage.

Power conditioning circuit board 146 may be a device that is configured to improve the quality of the power that is delivered from power generator 144 to energy storage device 148 and/or external devices. Power conditioning circuit board 146 may be configured to regulate a voltage and the characteristics of the electrical power to enable energy storage device 148 and/or external devices to function properly. Power conditioning circuit board 146 may also include a voltage regulator to improve a power factor correction, noise suppression, transient impulse protection, etc. In embodiments, power conditioning circuit board 146 may be configured to be positioned within the lower chamber within inner frame 130.

Energy storage device 148 may be a battery or any other device that is configured to store energy. For example, energy storage device 148 may be an electrochemical cell that is configured to receive electrical power from power generator 144 via power conditioning circuit board 146. In embodiments, energy storage device 148 may be positioned within inner frame 130 or between inner frame 130 and outer frame 112. Energy storage device 148 may have ports that are accessible via the hollow opening within inner frame 130, such that a user may charge an external device while positioned within the hollow opening. Accordingly, while the external device is receiving power from energy storage device, the external device may add to the weight of objects stored within the hollow chamber to increase the mechanical force generated by inner frame 130.

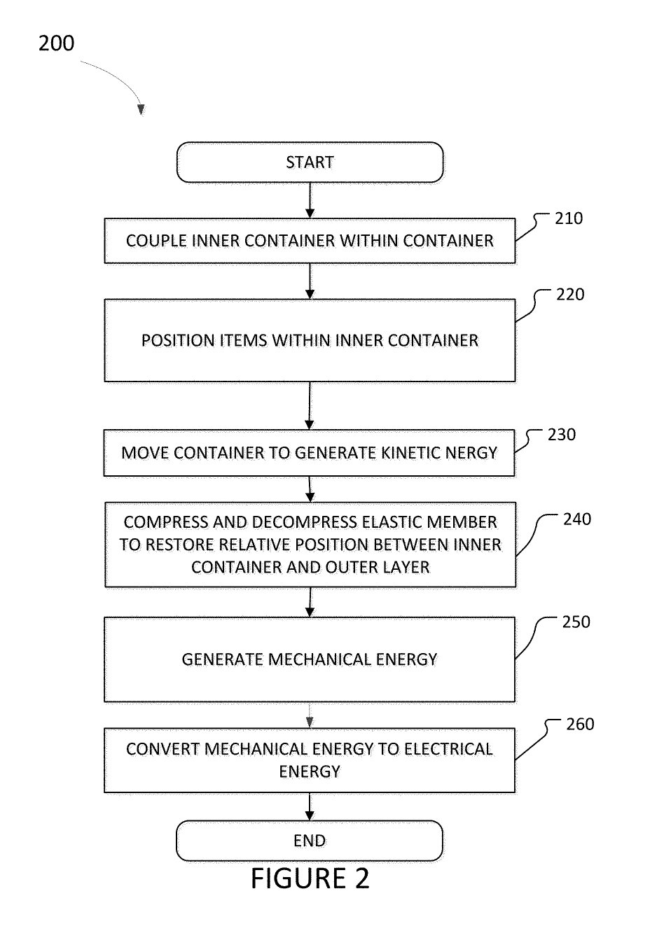

FIG. 2 illustrates a method 200 for harvesting motional energy. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 210, an inner frame may be coupled within a hollow chamber in a container. The inner frame may be coupled to the hollow chamber via an elastic member, wherein a first end of the elastic member is coupled to an outer frame of the container, and a second end of the elastic member is coupled to the inner frame. This coupling may allow the inner frame to move in a controlled and frequent manner in relation to the outer frame.

At operation 220, items may be positioned within a body of the inner frame. Responsive to the items being positioned within the inner frame, the weight of the inner frame may correspondingly increase.

At operation 230, the container may be moved. Responsive to the container moving, the inner frame positioned within the container may move relative and at a different rate than an outer frame of the container. This may generate kinetic energy.

At operation 240, when the inner frame moves relative to the outer frame of the container, the elastic member may restore the relative position between the inner frame and the outer layer, such that the movement of the inner frame is repeatable.

At operation 250, the mechanical force generated by the compression and decompression of the elastic member may move a gear chain coupled with the outer frame of the container and a hollow chamber of the inner frame to transfer the mechanical energy to a power generator.

At operation 260, the power generator may convert the mechanical energy to electrical energy, which may be used to power external devices that are positioned within the inner frame.

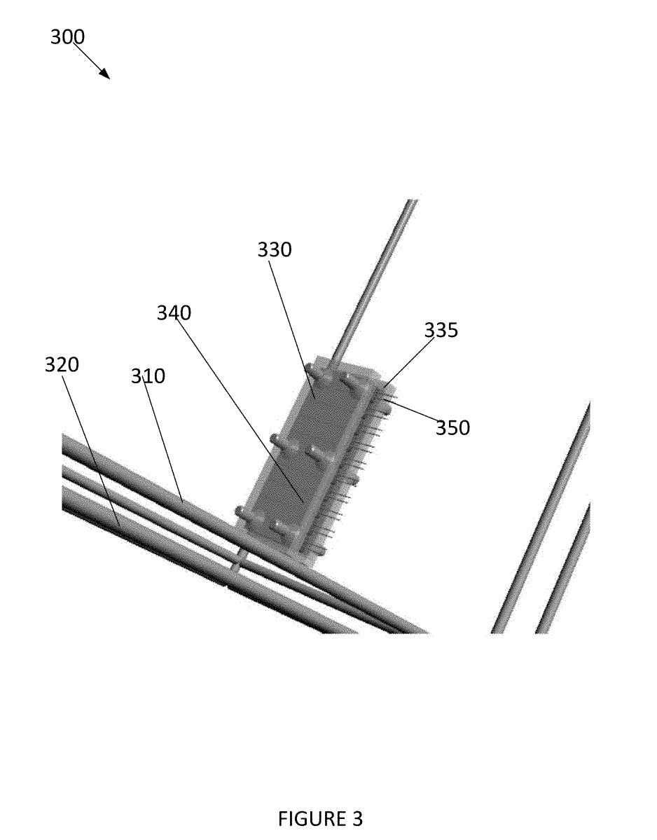

FIG. 3 depicts a device 300 configured to generate energy based on the movement of an inner frame 310 in relation to an outer frame 320, according to an embodiment. Elements discussed above in accordance within device 100 may be incorporated within device 300. For the sake of brevity, a further description of these elements, such as the springs and/or power generator is omitted.

As depicted in FIG. 3, device 300 may include an inner frame 310 and an outer frame 320, wherein inner frame 310 may be positioned within outer frame 320. Inner frame 310 and outer frame 320 may each include a layer, fabric, etc. that is configured to form a container, bag, etc. In embodiments, inner frame 310 may be configured to move relative to and within outer frame 320, wherein outer frame 320 may remain substantially static. In embodiments, springs may be utilized to couple inner frame 310 and outer frame 320.

Device 300 may also include a mounting bracket 330, channel 335, magnets 340, and coils 350.

Mounting bracket 330 may be configured to be positioned within inner frame 310 via screws, bolts, or any other form of coupling mechanism. Mounting bracket 330 may be secured within inner frame 310 such that when inner frame 310 moves, mounting bracket 330 may correspondingly move. Mounting bracket 330 may be comprised of two plates, wherein magnets 340 may be positioned between the plates. In embodiments, a channel 335 may be formed between the two plates, wherein the channel 335 is formed proximate to an sidewall of layer of fabric encompassed by inner frame 310. In other words, an inner chamber may be formed within inner frame 310, and the channel 335 may be positioned adjacent to the fabric forming the inner chamber. Channel 335 may be a groove, slot, indention, etc. within mounting bracket 330, wherein channel 335 may be configured to guide the movement of coils 350 relative to magnets 340.

Magnets 340 may be any type of device that is configured to create a magnetic field. Magnets 340 may be arranged in alternating polarity, such that each adjacent magnet 340 may be the opposite polarity. Magnets 340 may be positioned between the plates of mounting bracket 330. Magnets 340 may have a shorter width than the plates, such that channel 335 may be formed between the ends of magnets 340 and the plates.

Coils 350 may be electromagnetic coils coupled to a sidewall of fabric covering outer frame 320. A first end of coils 350 may be coupled to a sidewall of the fabric covering outer frame 320, and a second end of coils 350 may be positioned within inner frame 310. Specifically, the second end of coils 350 may be positioned within channel 335. Responsive to inner frame 310 moving relative to outer frame 320, mounting bracket 330 may move the magnets 340 relative to coils 350, which are positioned within channel 335. The movement of the magnets 340 relative to the coils 350 may cause each coil 350 to experience a rapid change of magnetic flux, which generates voltage. This voltage may be used by the power generator.

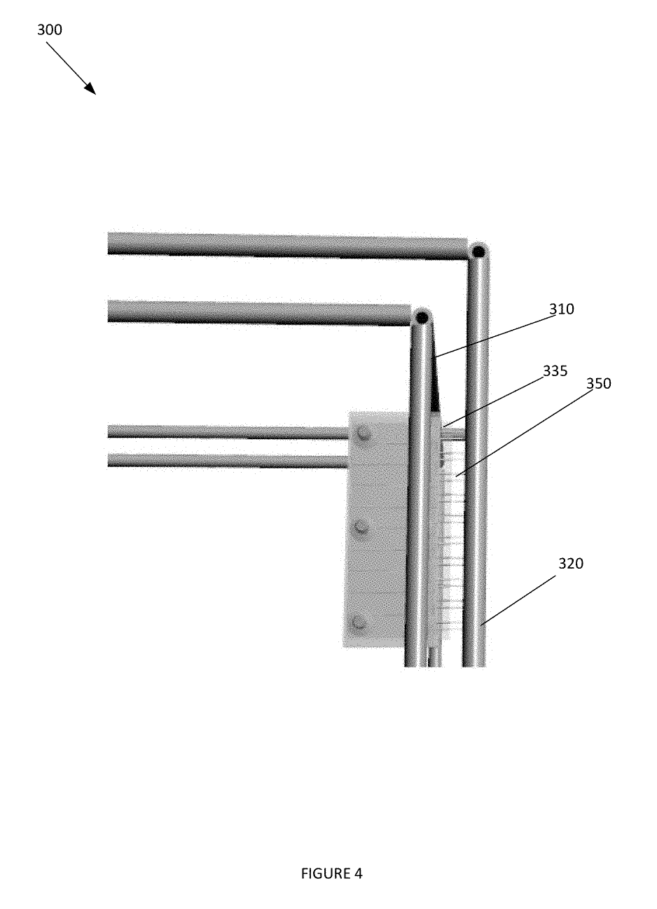

FIG. 4 depicts a device 300 configured to generate energy based on the movement of an inner frame 310 in relation to an outer frame 320, according to an embodiment. Elements discussed above in accordance within device 100 may be incorporated within device 300. For the sake of brevity, a further description of these elements, such as the springs and/or power generator is omitted.

As depicted in FIG. 4, coils 350 may have first ends that are positioned adjacent to an inner surface of a layer associated within outer frame 320. A second end of coils 350 may have second ends that extend into channel 335 positioned within channel 335, but do not touch magnets 340. As inner frame 310 moves, second end of coils 350 may move relative to the magnets 340.

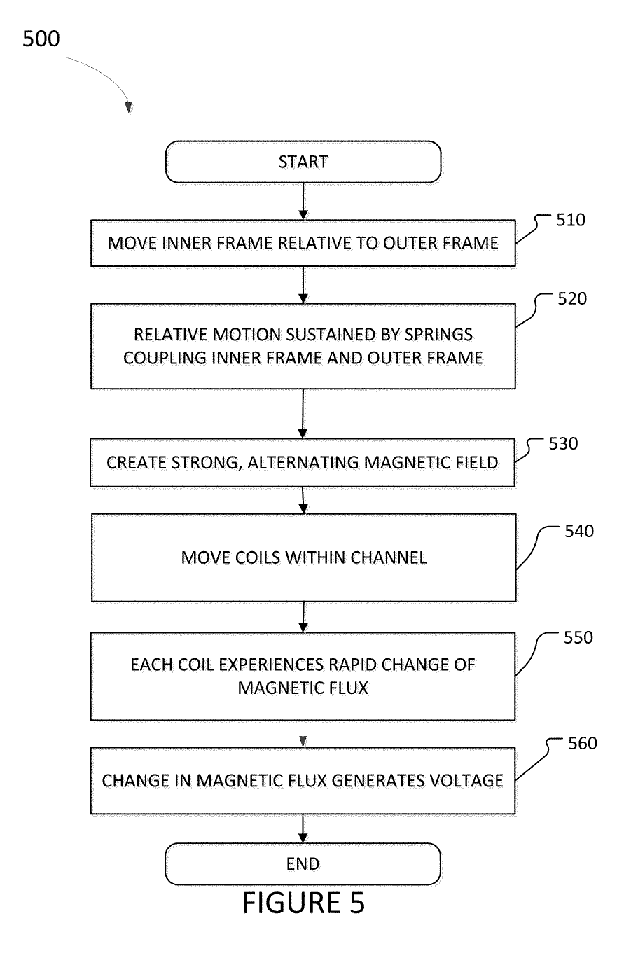

FIG. 5 illustrates a method 500 for harvesting motional energy. The operations of method 500 presented below are intended to be illustrative. In some embodiments, method 200 may be accomplished with one or more additional operations not described, and/or without one or more of the operations discussed. Additionally, the order in which the operations of method 500 are illustrated in FIG. 5 and described below is not intended to be limiting.

At operation 510, an inner frame may move relative to an outer frame.

At operation 520, springs coupling the inner frame to the outer frame may maintain the relative motion of the inner frame with respect to the outer frame.

At operation 530, a strong, alternating magnetic field may be generated by a magnetic array. The magnetic array may be formed of by positioning magnets in alternating polarities between two plates, wherein a channel may be formed between the ends of the magnetic array and the plates.

At operation 540, coils may move within a channel based on the relative movement of the inner frame and the outer frame.

At operation 550, responsive to the coils moving within the channel, each coil may experience a rapid change of magnetic flux.

At operation 560, through faraday's law, based on the change in magnetic flux on each of the coils, voltage may be generated. This voltage may be stored within a power generator and used to supply power to an electrical device.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed:

1. A system for harvesting motional energy comprising:
an outer frame forming a first container;
an inner frame forming a second container positioned within the outer frame, wherein the outer frame;
a mounting bracket positioned within the second container, the mounting bracket including two plates;
an alternating magnetic field formed by arranging magnets of alternating polarities adjacent to each other within the plates, wherein a channel is formed between ends of the alternating magnets and the plates;
coils configured to cause a voltage to be induced based on a change of magnetic flux, the coils having a first end coupled to the first container and second ends positioned within the channel, wherein responsive to the inner frame moving relative to the channel will correspondingly move with respect to the coils.

2. The system of claim 1, wherein responsive to the coils moving within the channel, each of the coils experiences a rapid change of magnetic flux.

3. The system of claim 2, wherein the voltage is changed based on the coils moving within the channel, the voltage being stored within a power generator.

4. The system of claim 1, further comprising:
springs coupling the inner frame and the outer frame, wherein the springs are configured to control the relative movement of the inner frame with respect to the outer frame such that the coils continually move within the channel.

5. The system of claim 1, wherein the second ends of the coils are positioned proximate to the magnets within the inner frame.

6. The system of claim 1, wherein a width of the plates is larger than a width of the magnets.

7. The system of claim 1, wherein the inner frame and the outer frame are comprised of carbon fiber.
